(19) United States
(12) Patent Application Publication
(10) Pub. No.: US 2004/0045979 A1
(43) Pub. Date: Mar. 11, 2004

(54) Particle dispense rate regulator

(76) Inventor: Bruce Macmichael, Melbourn (GB)

Correspondence Address: NIXON & VANDERHYE, PC, 1100 N GLEBE ROAD, 8TH FLOOR, ARLINGTON, VA, 22201-4714, US

(21) Appl. No.: 10/433,310

(22) PCT Filed: Nov. 30, 2001
(86) PCT No.: PCT/GB01/05317

(30) Foreign Application Priority Data
Dec. 1, 2000 (GB) 0029362.1

(51) Int. Cl. G01G 13/06

(52) U.S. Cl. 222/1; 222/199; 222/196; 222/486

(57) ABSTRACT

A particle dispenser and method of regulating the rate of dispensing of particles is disclosed in which particles are dispensed through a plurality of apertures having a variable effective area defined as the total area of apertures through which particles can be dispensed at any given time. The effective area is varied so as to provide a high dispense rate initially and a lower dispense rate later on in the dispense cycle. In this way, relatively larger quantities of particles can be dispensed accurately and in a reasonable amount of time.

The present invention broadly relates to the dispensing of small quantities of particles to a container or other receptacle. In particular, the present invention relates to a particle dispenser which dispenses particles to a mass measuring device upon the application of mechanical energy to the dispenser.

The present inventors have already proposed in International Patent Application No. PCT/GB00/04220 an apparatus and method for dispensing particles which allows very small masses of particles to be dispensed with high accuracy. The system disclosed in PCT/GB00/04220 is generally similar to that illustrated in FIG. 15 of the accompanying drawings.

The apparatus of PCT/GB00/04220 comprises a particle dispenser 100 containing a quantity of the particles 10 to be dispensed. The particles may be formulations of a pharmaceutical such as Lidocaine having an average diameter of 30 μm, for example. The particles are dispensed to a cassette (receptacle) 20 set on a mass measuring device, such as a balance 30. The particle dispenser 100 generally has two components; a hopper 110 and a sieve 120 mounted across the bottom cross section 110. The sieve 120 comprises a plurality of apertures which are each larger than the average particle size of the particles 10. In the steady state, the particles 10 tend to “clog” the sieve 120 such that they do not pass through it. However, upon the application of mechanical energy to the particle dispenser 100, the particles are momentarily disturbed and some are able to fall through the plurality of apertures in the sieve 120. The apparatus is arranged so that these dispensed particles land in the cassette 20. The term “cassette” should be taken to include all types of container, including containers which may be swallowed whole by the patient for example.

In the apparatus of PCT/GB00/04220, mechanical energy is applied to the particle dispenser 100 by a solenoid 40 which imparts a horizontal force to the side of the hopper 110. The actuator is controlled by a processor 50 and the processor 50 is in turn connected to the mass measuring device 30. Thus, closed-loop operation can be obtained by controlling the actuator 40 to tap the particle dispenser 100 so as to dispense particles to the cassette 20 on the mass measuring device 30 until a desired mass of particles has been dispensed.

To achieve dispensing to a very high accuracy, it is necessary to be able to dispense particles at a very low rate. However, using a low dispense rate means that it can take a considerable amount of time to dispense the desired total mass of particles. Thus, it is preferable that dispensing is initiated at a high dispense rate, which dispense rate reduces as the target mass is approached. This allows particles to be dispensed to a high accuracy in a reasonable amount of time.

PCT/GB00/04220 describes two ways of regulating the dispense rate during the dispensing process. Firstly, the intensity of mechanical excitation can be reduced to reduce the dispense rate. For example, if the voltage applied to the solenoid 40 in the accompanying FIG. 15 is reduced, this results in some reduction in the impact energy transmitted to the particle dispenser 100 with a resulting reduction in the number of particles that are dislodged by each actuation. This method is effective over a limited range, but there is a voltage below which little or no powder is delivered and there is a higher voltage above which the amount of powder delivered increases only slightly. Thus, this method of controlling the dispense rate has limitations which it is desired to overcome.

Secondly, the frequency with which the particle dispenser 100 is mechanically excited can be varied. For example, mechanically exciting the particle dispenser 100 half as often results in the apparent time-averaged overall particle dispense rate being reduced to half its previous value. Thus, the time-averaged dispense rate can be reduced by simply waiting for a larger amount of time between successive mechanical actuations. This method has the limitation that reducing the dispense rate in this way does not achieve the goal of increased accuracy. This is because the particles are delivered in discrete “doses” following each mechanical actuation. The final weighing accuracy that can be achieved is no greater than the size of each dose. Controlling the frequency of the mechanical actuator does not change the size of each delivered dose but only the amount of time between successive doses. Thus, to achieve good accuracy, the dose size must be kept small by using a sieve that is found to deliver only a small number of particles for each mechanical actuation. For example, if it is required to dispense particles with a tolerance of +/−10 micrograms, then each dose needs to be less than 20 micrograms. To ensure that all doses are less than 20 micrograms, it is necessary to ensure that the average dose size is about 4 micrograms. This makes it very difficult to dispense relatively large quantities of particles quickly. For example, if the maximum average dose size is 4 micrograms, and the particle dispenser 100 is able to be actuated a maximum of 30 times per second, then the maximum dispense rate of 120 micrograms per second is achievable. At this rate, it would take over one minute to dispense 10 milligrams of particles. If the maximum dose size is increased, then it becomes impossible to deliver the particles to the required accuracy. Thus, changing the frequency does not solve the problem.

Both of the above described dispense rate controlling methods are effective over only a limited range. Further, they have a second disadvantage in that they are not necessarily predictable. The dispense rate achieved is not necessarily linearly proportional to the control parameter (such as the level of solenoid voltage or the frequency of actuation).

The present invention aims to alleviate the above mentioned problems by providing that the effective area through which the particles are dispensed can be actively controlled during a dispense cycle. Thus, the invention allows higher individual doses of particles to be dispensed per actuation at the beginning of a dispense cycle and lower individual doses per actuation to be delivered towards the end of a dispense cycle. This allows relatively large quantities of particles to be dispensed to high accuracy in a small amount of time.

According to a first aspect of the present invention there is provided a particle dispenser for dispensing particles to a mass measuring device, said particle dispenser comprising:

a hopper for holding a supply of particles to be dispensed;

a plurality of apertures through which said particles are to be dispensed, said plurality of apertures having a variable effective area defined as the total area of said apertures through which particles can be dispensed at any given time; and

means for varying said effective area over time to vary the rate at which particles can be dispensed from said hopper through said apertures.

According to a second aspect of the present invention there is provided a method of regulating the rate of dispensing of particles from a particle dispenser, the method comprising:

providing a plurality of apertures for the dispensing of particles from a hopper and then varying the effective area of said plurality of apertures through which particles are being dispensed, said effective area being defined as the total area of said apertures through which particles can be dispensed at any given tine.

The effective area through which the particles are dispensed is preferably varied by moving an adjustment member.

The adjustment member may comprise a substrate at the base of the hopper through which the plurality of apertures are provided. For example, in the context of the FIG. 15 apparatus, the sieve 120 may be moved to one side so as to present fewer apertures to the particles in the hopper 110.

The adjustment member may alternatively or additionally comprise a masking portion for selectively covering some of the plurality of apertures. In this case, either the masking member itself or the substrate comprising the plurality of apertures may be moved relative to one another so that some of the apertures are masked. This provides that the number of apertures presented to the inside of the hopper can be varied.

The adjustment member may comprise a further substrate comprising a further plurality of apertures movable with respect to the first plurality of apertures so as to selectively line up therewith. Thus, the effective aperture area can be controlled by moving one or both of two substrates, each having the same pattern of apertures, with respect to one another. This allows the number of apertures presented to the inside of the hopper to be accurately controlled. Another advantage is that the effective area of apertures can rapidly be reduced to zero, if the space between adjacent apertures is equal to or greater than the diameter of the apertures themselves. This allows the dispense rate to be reduced very quickly.

The adjustment may be carried out by moving the adjustment member in the horizontal plane, perpendicular to the direction in which the particles move as they are dispensed. This may in practice be carried out by either rotating or translating the adjustment member in this plane.

To ensure predictable and repeatable operation, it is useful to provide that the effective area of the plurality of apertures varies linearly with the amount of movement of the adjustment member. Thus, the dispense rate can be linearly controlled using a signal which is varied linearly.

It is advantageous to decrease smoothly the effective area and therefore also the dispense rate as the target mass is approached. Decreasing the dispense rate increases the tolerance and so a dispense cycle can be set up in which the rate of dispensing is set to be proportional to the amount of mass left to be dispensed. Thus, smaller and smaller doses of particles are delivered upon successive actuations as the target mass is approached. It can therefore be arranged that the present maximum dose size is never larger than the mass to be dispensed plus the tolerance. In such cases, the dispense rate reduces substantially exponentially over time. It is then useful that the effective aperture area varies exponentially in reaction to a linearly time-varying control signal. In this way, the adjustment member can be linearly moved at a constant velocity to achieve a substantially exponential reduction of the dispense rate with time.

To ensure predictability, the apertures are preferably grouped together in a regular pattern.

According to a third aspect of the present invention there is provided a dispensing apparatus comprising the particle dispenser of the above described first aspect of the present invention, a mass measuring device for receiving particles from the particle dispenser and a particle release actuator for causing some of the supply of particles to be dispensed from the particle dispenser.

The present invention will be further described, by way of non-limitative example only, with reference to the accompanying schematic drawings in which:

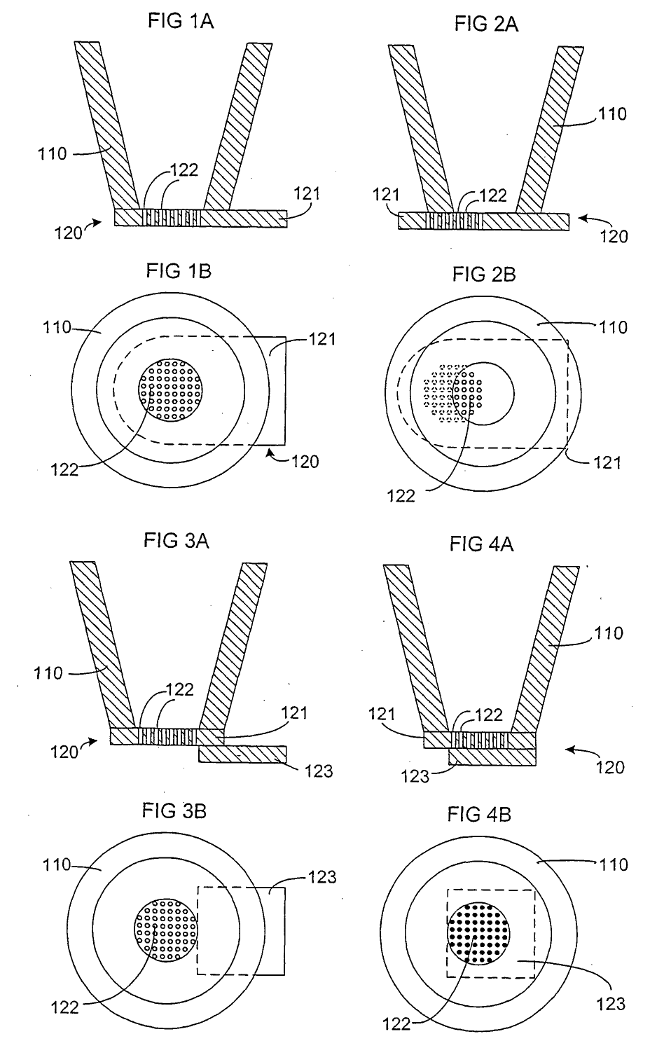

FIGS. 1A and 1B show a cross-sectional side view and plan view, respectively, of a particle dispenser according to a first embodiment of the present invention when in the fully open state;

FIGS. 2A and 2B show a cross-sectional side view and a plan view, respectively, of a particle dispenser according to the first embodiment of the present invention when in a partially open state;

FIGS. 3A and 3B show a cross-sectional side view and plan view, respectively, of a particle dispenser according to the second embodiment of the present invention when in the fully open state;

FIGS. 4A and 4B shows a cross-sectional side view and a plan view, respectively, of a particle dispenser according to the second embodiment of the present invention when in a fully closed position;

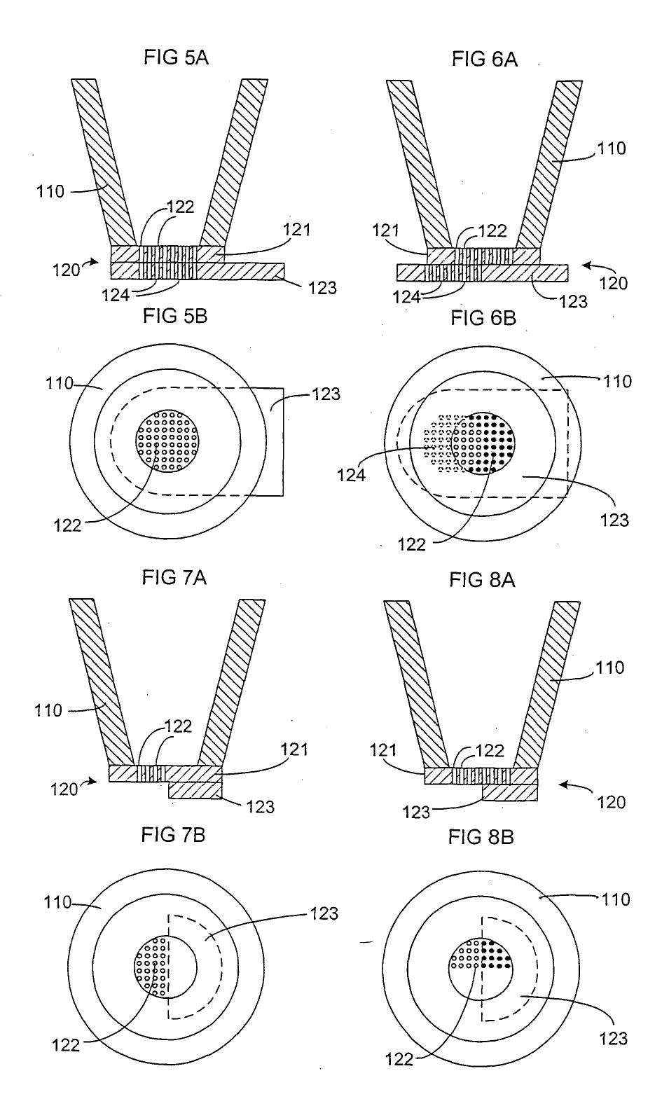

FIGS. 5A and 5B show a cross-sectional side view and plan view, respectively, of a particle dispenser according to a third embodiment of the present invention when in the fully open state;

FIGS. 6A and 6B show a cross-sectional side view and a plan view, respectively, of a particle dispenser according to the third embodiment of the present invention when in a partially open state;

FIGS. 7A and 7B shows a cross-sectional side view and plan view, respectively, of a particle dispenser according to a fourth embodiment of the present invention when in the fully open state;

FIGS. 8A and 8B show a cross-sectional side view and a plan view, respectively, of a particle dispenser according to the fourth embodiment of the present invention when in a partially closed position;

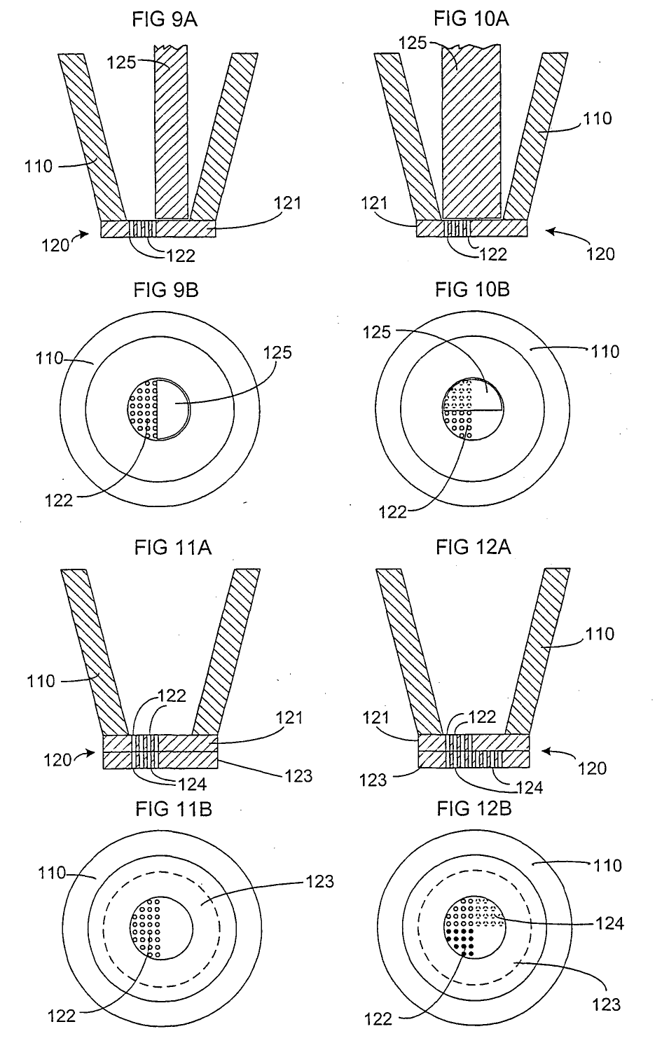

FIGS. 9A and 9B show a cross-sectional side view and plan view, respectively, of a particle dispenser according to a fifth embodiment of the present invention when in the fully open state;

FIGS. 10A and 10B show a cross-sectional side view and a plan view, respectively of a particle dispenser according to the fifth embodiment of the present invention when in a partially closed position;

FIGS. 11A and 11B show a cross-sectional side view and plan view, respectively, of a particle dispenser according to a sixth embodiment of the present invention when in the fully open state;

FIGS. 12A and 12B show a cross-sectional side view and a plan view, respectively of a particle dispenser according to the sixth embodiment of the present invention when in a partially closed position; and

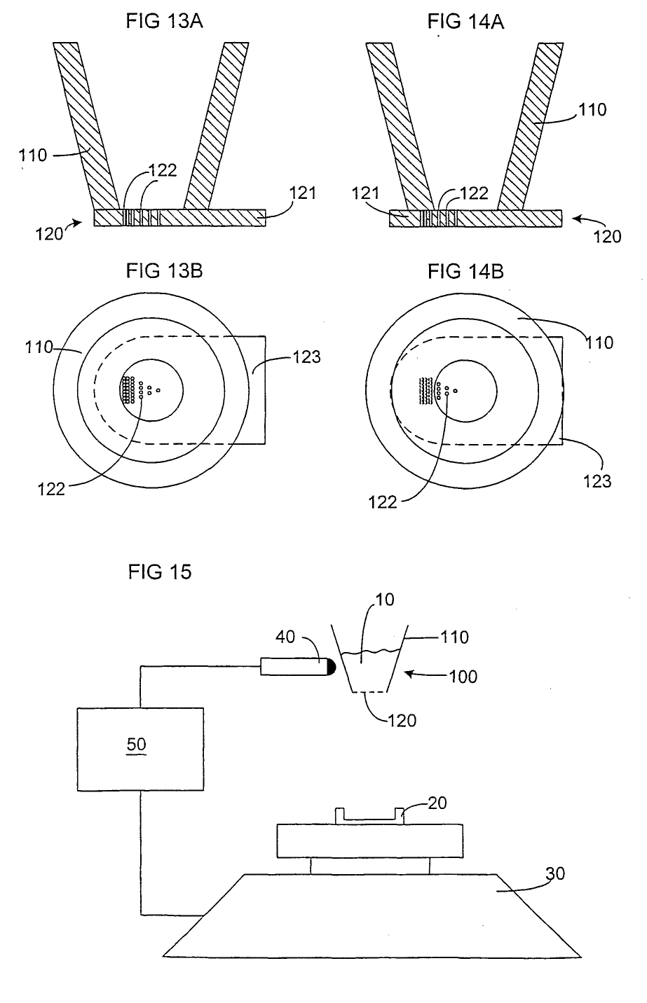

FIGS. 13A and 13B show a cross-sectional side view and plan view, respectively, of a particle dispenser according to a seventh embodiment of the present invention when in the fully open state;

FIGS. 14A and 14B show a cross-sectional side view and a plan view, respectively, of a particle dispenser according to the seventh embodiment of the present invention when in a partially open state;

FIG. 15 shows apparatus for dispensing particles according to the present invention.

First Embodiment

A first embodiment of the particle dispenser of the present invention is shown in FIGS. 1A, 1B, 2A and 2B. In these Figures, and in all of the other Figures showing embodiments of the invention, the particles 10 are not shown for the sale of clarity.

As can be seen from the cross-sectional side views, the particle dispenser comprises a hopper 110 having a generally frusto-conical shape and an open top. The open top allows a fresh supply of particles to be supplied to the hopper. At the base of the hopper, a substrate 121 having a plurality of apertures 122 is provided. The substrate 121 and hopper 110 are relatively movable in the horizontal plane in the left/right direction as shown in FIGS. 1 and 2. It is preferred to keep the hopper 110 stationary and to move the substrate 121 relative to the hopper. Means for supporting and moving the substrate 121 relative to the hopper 110 are not shown also for the sake of clarity, but may for example take the form of a stepper motor or solenoid supported on a frame.

FIGS. 1A and 1B show the state in which all of the apertures 122 are opened to the inside of the hopper. The plurality of apertures have an effective area defined as the total area of the apertures through which particles can be dispensed at any given time. In FIG. 1B, this effective area corresponds to the sum of the area of each of the individual apertures. In this configuration, the maximum possible particle dispense rate may be achieved.

FIGS. 2A and 2B show an arrangement whereby the substrate 121 has been translated to the left so that some of the formerly open apertures 122 are now obscured from the inside of the hopper by the edge of the hopper 110. In FIG. 2B, only twenty of the fifty-two apertures are now presented to the inside of the hopper. Accordingly, the effective area is the total area of those twenty apertures and the reduction in this effective area ill result in a corresponding reduction in the dose of particles dispensed, when the particle dispenser is mechanically excited. This in turn serves to reduce the time-averaged dispense rate. This embodiment has a number of settings. FIG. 1B shows the most open setting in which all fifty-two of the apertures are presented to the inside of the hopper. The substrate 121 may then be moved so as to obscure the leftmost four apertures and the two outer apertures in the second and third columns. Thus, the number of apertures can be reduced from 52 to 44, and then 36, to 28, to 20, to 14, to 8 and finally to 4. This provides eight settings with which the number of apertures may be approximately linearly reduced, at least initially. More linearity can be achieved by providing less apertures on the substrate 121 or by changing the pattern of holes and the internal shape of the hopper so that the same number of apertures are obscured with each movement of the substrate. Of course, there exists a number of further settings in which some of the apertures are only partially obscured by the edge of the hopper which provides for a smooth transition between one setting and the next.

Second Embodiment

FIGS. 3A, 3B, 4A and 4B respectively show the fully open and fully closed position for a second embodiment of the particle dispenser. FIG. 3A shows the hopper 110 which is substantially the same as that shown in FIG. 1. In this embodiment, the substrate 121 comprising the apertures 122 is fixed with respect to the hopper 110. The adjustment member comprises a masking plate 123 which is arranged to slide linearly across the substrate 121. In this way, some or all of the plurality of apertures 122 may be blocked so that particles cannot pass therethrough.

FIGS. 4A and 4B show the configuration in which the masking plate 123 blocks all of the apertures 122. In practice, when dispensing particles, it is preferable not to block all of the apertures because otherwise dispensing cannot be carried out. However, it may be useful to block all of the apertures in periods in which dispensing is not being carried out, for example when the cassette being filled is removed and replaced or in between batches or during periods when the apparatus is switched off.

Third Embodiment

FIGS. 5A, 5B, 6A and 6B show a third embodiment of the present invention.

A substrate 121 comprising the apertures 122 is fixed relative to the hopper 110 so the particles can pass from the hopper 100 through the apertures 122. A second substrate 123 has a second plurality of apertures 124 and is provided adjacent to the first substrate 121 so that it may be translated in the horizontal plane. Moving substrate 123 varies the number of apertures 124 which line up with the static apertures 122. Thus, the effective area of apertures can be predictably and reliably controlled, resulting in predictable and reliable controlling of the overall dispense rate.

The apparatus of the third embodiment may be operated in a plurality of ways. In a first way, as shown in FIGS. 5A, 5B, 6A and 6B, the substrate 123 can be moved so as to selectively line up apertures in the substrate 121 with apertures in the substrate 123. In this way, the total number of apertures effective for particle dispensing can be varied. In a second way, the substrate 123 can be moved by relatively small amounts so as to partially obscure all of the apertures. In this way, the effective size of all the apertures in substrate 121 can be varied.

Fourth Embodiment

FIGS. 7A, 7B, 8A and 8B illustrate a fourth embodiment of the present invention.

In this embodiment, the substrate 121 is provided to rotate relative to the hopper 110 in the horizontal plane. The apertures 122 are provided over approximately half of the area of the substrate 121 which is visible from inside the hopper. A masking substrate 123 is provided adjacent to the rotatable substrate 121 so as to mask approximately half the area which is visible inside the hopper. The effective area of the apertures can be varied by rotating the substrate 121 about the centre line of the hopper so that an increasing proportion of the apertures in the substrate 121 are masked by the masking substrate 123. Alternatively, the masking substrate 123 may be turned relative to a stationary substrate 121.

This apparatus has the advantage that the components 121 and 123 are smaller than are required if translation is used to adjust the effective area rather than rotation. However, it has the disadvantage that the whole area at the bottom of the hopper cannot be used to dispense particles. A maximum of half the area can be used for this purpose.

Fifth Embodiment

FIGS. 9A, 9B, 10A and 10B illustrate a fifth embodiment of the present invention.

In this embodiment, the substrate 121 having a plurality of apertures 122 is fixed relative to the hopper 110. A movable masking member 125 is provided inside the hopper and, as can be seen from the top views, it has a substantially semi-circular cross-section. Rotation of the member 125 selectively masks certain of the apertures 122 so as to adjust the effective aperture area.

This embodiment has the advantage that no extra components external to the hopper are required, but has the disadvantage that space in the hopper for particles 10 is taken up by the member 125.

Sixth Embodiment

FIGS. 11A, 11B, 12A and 12B illustrate the sixth embodiment of the present invention.

In this embodiment, two substrates 121 and 123 are provided which are identical in that they both comprise a plurality of apertures having the same configuration. In this embodiment the substrate 121 is fixed relative to the hopper 100 and the substrate 123 is rotatable, relative to the substrate 121 and the hopper 100, about the centre line of the hopper. In this way, the plurality of apertures 124 can be made to selectively line up with some of the plurality of apertures 122 so as to vary the effective area of the apertures. The area can be varied from fully open, as shown in FIGS. 11A and 11B to a position in which only thirteen of the apertures line up as shown in FIGS. 12A and 12B. There also exists a fully closed position. Different pattens of apertures can provide that there are a plurality of possible settings between fully open and fully closed. Although not shown, it is possible to devise aperture patterns which cover more than 50% of the hopper base area.

It is also to be noted that the substrate 121 could be made movable relative to the substrate 123 and the apparatus would still operate.

Seventh Embodiment

The above embodiments all show particle dispensers in which movement of one of the substrates 121, 123, results in a corresponding generally linear reduction in the effective aperture area present. However, in some cases it may be desirable for this relationship to be non-linear, especially exponential.

An exponential relationship means that a linear movement of the adjustment member results in an exponential reduction in the effective aperture area, for example the effective aperture area could halve for each millimetre that the adjustment member is moved.

FIGS. 13A, 13B, 14A and 14B show views similar to FIGS. 1A, 1B, 2A and 2B in which the substrate 121 is provided with a plurality of apertures 122 that provide for a substantially non-linear increase in the effective aperture area in response to a linear movement of the substrate 121. As can be seen, this is achieved by ensuring that the number of revealed apertures increases exponentially as the substrate 121 moves. In the Figures it is possible to reveal either 1, 2, 4, 8, 16 or 32 apertures in total, the number of revealed apertures doubling each time the substrate 121 moves a set distance. The same exponential performance can be achieved by equivalent modification to any of the second to sixth embodiments too.

A preferred dispensing apparatus is shown in FIG. 15. The particle dispenser 100 is constructed substantially as arranged in any of the described embodiments. Means to adjust the effective area of the apertures is provided although not shown in FIG. 13 for clarity. Such means may comprise a linear actuator or stepper motor for example.

The above described embodiments show particle dispensers which allow for continuous variation in the effective area of the apertures. This allows the apparatus of FIG. 15 to be used in an optimal fashion such that high dispense rate, low accuracy dispensing can be used at the start and low dispense rate, high accuracy dispensing can be used near the end of the cycle when accuracy is required. This change of dispense rate can span a considerable range, eg. a ratio of 10:1 is easily obtainable. A further advantage is that the change is highly predictable, since the amount of dose delivered per unit effective aperture area tends to be repeatable. Thus, the control algorithm used in the processor 50 to control the solenoid 40 can make an accurate prediction of the effect on the dispense rate of changing the effective aperture area.

In each of the embodiments above, the particles 10 in hopper 100 may be dislodged by tapping the side of the hopper 100 (as shown in FIG. 15), or alternatively by tapping or vibrating the substrates 121 or 123 themselves. In this latter case, the device which adjusts the effective area of the apertures can be combined with the means for tapping/vibrating the particle dispenser to provide an advantageous use of equipment.

The above embodiments show particle dispensers in which all the apertures 122 or 124 have the same diameter. However, it can be provided that apertures having a range of different diameters are provided together on the same substrate. This helps to mitigate the limitation described above that there is a small window between the minimum possible dispense rate and maximum possible dispense rate when the apertures are static and fixed in size. This arrangement of differently sized apertures extends the window because the larger apertures tend to dispense particles even with very light taps, lowering the minimum dispense rate and the smaller apertures start dispensing at higher tap voltages, increasing the maximum dispense rate. Using differently sized apertures therefore also meets the objective of providing a more controllable particle dispense cycle because it increases the range of dispense rates possible.

A preferred method of dispensing particles will now be described, by way of example only, with reference to FIG. 15. Firstly, the particle dispenser is adjusted to ensure that the maximum possible effective aperture area is presented to the inside of the hopper 100. The processor 50 then causes the actuator 40 to mechanically agitate the particle dispenser so that a dose of particles falls through the apertures and into the cassette 20. The dose is weighed by the balance 30 and this weighing signal is relayed to the processor 50. The processor continues to supply a signal to the actuator 40 until some predetermined mass of particles has been dispensed. The processor then adjusts the particle dispenser to reduce the effective aperture area and thus the dose of particles that will be dispensed upon future taps by the actuator 40. This allows greater accuracy to be achieved in the final stages of dispensing.

An alternative method comprises continuously adjusting the particle dispenser to reduce the dispense rate in proportion to the total mass of particles dispensed. In this way, an optimum method in which the dose to be dispensed on the next actuation is equal to or smaller than the remaining mass to be dispensed can be achieved.

In the final stages of dispensing, it is useful that the maximum mass of particles in a dose is less than the tolerance value. This can be achieved by arranging that the particle dispenser has a minimum possible deliverable dose less than the tolerance value. Similarly, ensuring that the dispenser has a maximum possible deliverable dose much bigger (eg 5 or 10 times bigger) than the tolerance value is useful to ensure that large doses may be delivered in the early stages of the dispense cycle.

1. A particle dispenser for dispensing particles to a mass measuring device, said particle dispenser comprising:
a hopper for holding a supply of particles to be dispensed;
a plurality of apertures through which said particles are to be dispensed, said plurality of apertures having a variable effective area defined as the total area of said apertures through which particles can be dispensed at any given time; and
means for varying said effective area over time to vary the rate at which particles can be dispensed from said hopper through said apertures.

2. A particle dispenser according to claim 1 wherein said means for varying said effective area comprises a movable adjustment member.

3. A particle dispenser according to claim 2, wherein said adjustment member comprises a substrate at the base of the hopper through which said plurality of apertures are provided.

4. A particle dispenser according to claim 2, wherein said adjustment member comprises a masking portion for selectively covering some of said plurality of apertures.

5. A particle dispenser according to claim 2 or 4, wherein said, adjustment member comprises a substrate comprising a further plurality of apertures movable with respect to said plurality of apertures so as to selectively line up therewith.

6. A particle dispenser according to any one of claims 2, 4 or 5, wherein said adjustment member is provided in said hopper, abutting said plurality of apertures.

7. A particle dispenser according to any one of claims 3 to 6, wherein said adjustment member is movable substantially perpendicularly to the direction in which particles move as they are dispensed.

8. A particle dispenser according to any one of claims 3 to 7, wherein said adjustment member is rotatable about an axis parallel to the direction in which particles move as they are dispensed.

9. A particle dispenser according to any one of claims 2 to 8, wherein said effective area varies substantially linearly with the amount of movement of said adjustment member.

10. A particle dispenser according to any one of claims 2 to 8, wherein said effective area varies substantially exponentially with the amount of movement of said adjustment member.

11. A particle dispenser according to any one of the preceding claims, wherein said plurality of apertures are grouped together in a regular pattern.

12. A particle dispenser according to any one of the preceding claims, wherein said means for varying said effective area varies the number of apertures which are available for particle dispensing therethrough.

13. A particle dispenser according to any one of the preceding claims, wherein said means for varying said effective area varies the size of the apertures which are available for particle dispensing therethrough.

14. A dispensing apparatus for dispensing particles, said dispensing apparatus comprising:
a particle dispenser according to any one of the preceding claims;
a mass measuring device for receiving particles from said particle dispenser; and
a particle release actuator for causing some of said supply of particles to be dispensed from said particle dispenser.

15. An apparatus according to claim 14, wherein said particle release actuator is constructed and arranged to provide mechanical energy to the particle dispenser so as, in use, to cause some of the particles to be dispensed through said apertures.

16. A method of regulating the rate of dispensing of particles from a particle dispenser, the method comprising:
providing a plurality of apertures for the dispensing of particles from a hopper and then varying the effective area of said plurality of apertures through which particles are being dispensed, said effective area being defined as the total area of said apertures through which particles can be dispensed at any given time.

17. A method according to claim 16, wherein said step of varying the effective area of a plurality of apertures comprises moving an adjustment member.

18. A method according to claim 17, wherein said effective area varies substantially linearly with the amount of movement of said adjustment member.

19. A method according to claim 17, wherein said effective area varies substantially exponentially with the amount of movement of said adjustment member.

20 A method according to any one of claims 16 to 19, wherein said step of varying the effective area of a plurality of apertures comprises moving a substrate provided with said apertures.

21. A method according to any one of claims 16 to 20, wherein said step of varying the effective area of a plurality of apertures comprises selectively masking some of said plurality of apertures.

22. A method according to any one of claims 16 to 21, wherein said step of varying the effective area of a plurality of apertures comprises moving an adjustment member provided with a plurality of further apertures so as to selectively line up said plurality of further apertures with said plurality of apertures.

23. A method according to any one of claims 16 to 22, wherein said step of varying the effective area of a plurality of apertures comprises abutting said apertures with an adjustment member.

24. A method according to any one of claims 20 to 23, wherein said step of varying the effective area of a plurality of apertures comprises moving an adjustment member in a direction perpendicular to the direction in which particles are dispensed.

25. A method according to any one of claims 20 to 24, wherein said step of varying the effective area of a plurality of apertures comprises rotating an adjustment member about an axis parallel to the direction in which particles are dispensed.

26. A method according to any one of claims 16 to 25, wherein said step of varying the effective area of said plurality of apertures comprises varying the number of apertures which are available for particle dispensing therethrough.

27. A method according to any one of claims 16 to 26, wherein said step of varying the effective area of said plurality of apertures comprises varying the size of apertures which are available for particle dispensing therethrough.

28. A method of dispensing particles, said method comprising:
regulating a particle dispenser using a method according to any one of claims 16 to 27;
actuating a particle release actuator so as to provide mechanical energy to the supply of particles to be dispensed so that some of said supply of particles are dispensed through said apertures; and
measuring the mass of particles which have been dispensed through said apertures.

29. A method according to claim 28, wherein the size of the apertures is such that particles will only be dispensed therethrough in response to the provision of mechanical energy from the particle release actuator, and will not be dispensed in the absence of such provision.

30. A method of dispensing a predetermined mass of particles to a desired tolerance using the particle dispenser of any one of claims 1 to 13, the method comprising:
initially dispensing particles at a first dispense rate and, as the mass of dispensed particles approaches the predetermined mass, reducing the effective area of said plurality of apertures so as to reduce the dispense rate.

31. A method as claimed in claim 30, wherein the particles are dispensed by agitating the hopper.

32. A method as claimed in claim 31, wherein particles are dispensed by agitating an element in which the apertures are provided.

33. A method as claimed in any one of claims 30 to 32, wherein the minimum amount of particles dispensed from the hopper for a single dispensing agitation is less than or equal to the desired tolerance.

34. A method as claimed in any one of claims 30 to 33, wherein the maximum amount of particles dispensed from the hopper for a single dispensing agitation is greater than the desired tolerance.

35. A method as claimed in claim 34, wherein said maximum amount of particles capable of being dispensed is at least 5 times larger than said minimum amount of particles capable of being dispensed, preferably 10 times larger.

36. A particle dispenser for dispensing particles to a mass measuring device, said particle dispenser comprising:
a hopper for holding a supply of particles to be dispensed;
a plurality of differently-sized apertures through which said particles are to be dispensed.

37. A particle retainer constructed and arranged substantially as hereinbefore described, with reference to FIGS. 1 to 14 of the accompanying drawings.

38. A dispensing apparatus constructed and arranged substantially as hereinbefore described with reference to FIG. 15 of the accompanying drawings.

39. A method of regulating the rate of dispensing of particles substantially as hereinbefore described with reference to FIGS. 1 to 14 of the accompanying drawings.

40. A method of dispensing particles substantially as hereinbefore described with reference to FIG. 15 of the accompanying drawings.
